(19) United States
(12) Patent Application Publication
(10) Pub. No.: US 2010/0053187 A1
(43) Pub. Date: Mar. 4, 2010

(54) Method, Apparatus, and Computer Readable Medium for Editing an Avatar and Performing Authentication

(75) Inventors: Juha Henrik Arrasvuori, Tampere (FI); Marion Boberg, Suinula (FI); Jaakko Tapani Lehikoinen, Hameenkyro (FI); Petri Matti Olavi Piippo, Lempaala (FI); Hannu Juhani Korhonen, Kangasala (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/204,594

(22) Filed: Sep. 4, 2008

(51) Int. Cl. G09G 5/00; H04L 9/32

(52) U.S. Cl. 345/581; 726/2

(57) ABSTRACT

In accordance with an example embodiment of the present invention, an apparatus comprising a processor configured to determine a property associated with an access device; and automatically select a characteristic of an avatar based at least in part on the property is disclosed.

### RELATED APPLICATIONS

This application relates to U.S. application Ser. No. 12/080520, titled “Automated Selection of Avatar Characteristics for Groups,” filed Apr. 3, 2008, which is hereby incorporated by reference in its entirety. This application also relates to U.S. application Ser. No. 11/828,820, titled “Gesture Activated Close-Proximity Communication,” filed Jul. 26, 2007, which is hereby incorporated by reference in its entirety. This application also relates to U.S Pat. No. 7,069,003 titled “Method and Apparatus for Automatically Updating a Mobile Web Log (BLOG) to Reflect Mobile Terminal Activity,” filed Oct. 6, 2003, which is hereby incorporated by reference in its entirety. This application also relates to U.S Application No. 20080096549 titled “Mobile Communication Terminal,” filed Oct. 24, 2006, which is hereby incorporated by reference in its entirety.

### TECHNICAL FIELD

The present application relates generally to an avatar and authentication.

### BACKGROUND

There has been an unprecedented growth in electronic devices and communication services. There are currently many opportunities for a user to establish an account with a service. Such a service may allow the user to play a game, access information, interact with another user, and/or the like. Some services allow a user to utilize an avatar, such as a two dimensional image, a three dimensional image, and/or the like, when utilizing a service. Some services provide a user interface which may represent the avatar in relation to other information, such as other graphical information, an avatar of another user, and/or the like. For example, a social networking service may utilize avatars when users are communicating with each other. In another example, a multiplayer game may allow a user to experience the gaming environment in association with an avatar. In such an example, a user may be able to interact with another user via the usage of avatars.

### SUMMARY

Various aspects of the invention are set out in the claims.

In accordance with an example embodiment of the present invention, an apparatus comprising a processor configured to determine a property associated with an access device, and automatically select a characteristic of an avatar based at least in part on the property is disclosed.

In accordance with another example embodiment of the present invention, a method comprising determining a property associated with an access device, and automatically selecting a characteristic of an avatar based at least in part on the property is disclose.

In accordance with another example embodiment of the present invention, a computer program product comprising a computer-readable medium bearing computer program code embodied therein for use with a computer, the computer program code comprising code for determining a property associated with an access device and code for automatically selecting a characteristic of an avatar based at least in part on the property is disclosed.

In accordance with another example embodiment of the present invention, a computer-readable medium encoded with instructions that, when executed by a computer, perform determining a property associated with an access device and automatically selecting a characteristic of an avatar based at least in part on the property is disclosed.

In accordance with another example embodiment of the present invention, an apparatus, comprising a processor configured to compare at least one user avatar characteristic with at least one key avatar characteristic determine a first access authorization based at least in part on the comparing of the at least one user avatar characteristic, compare user authentication information with key user authentication information, and determine a second access authorization based at least in part on the comparing of the user authentication information is disclosed.

In accordance with another example embodiment of the present invention, a method, comprising comparing at least one user avatar characteristic with at least one key avatar characteristic, determining a first access authorization based at least in part on the comparing of the at least one user avatar characteristic, comparing user authentication information with key user authentication information, and determining a second access authorization based at least in part on the comparing of the user authentication information is disclosed.

In accordance with another example embodiment of the present invention, a computer program product comprising a computer-readable medium bearing computer program code embodied therein for use with a computer, the computer program code comprising code for comparing at least one user avatar characteristic with at least one key avatar characteristic, code for determining a first access authorization based at least in part on the comparing of the at least one user avatar characteristic, code for comparing user authentication information with key user authentication information, and code for determining a second access authorization based at least in part on the comparing of the user authentication information is disclosed.

In accordance with another example embodiment of the present invention, a computer-readable medium encoded with instructions that, when executed by a computer, perform comparing at least one user avatar characteristic with at least one key avatar characteristic, determining a first access authorization based at least in part on the comparing of the at least one user avatar characteristic, comparing user authentication information with key user authentication information, and determining a second access authorization based at least in part on the comparing of the user authentication information is disclosed.

### BRIEF DESCRIPTION OF THE DRAWINGS

For a more complete understanding of example embodiments of the present invention, reference is now made to the following descriptions taken in connection with the accompanying drawings in which:

FIGS. 1A and 1B are block diagrams showing example characteristics which may be associated with an avatar according to an example embodiment of the invention;

FIG. 2 is a block diagram showing a system which may benefit from the teachings of the invention;

FIG. 3 is a flow diagram showing a method for editing an avatar according to an example embodiment of the present invention;

FIGS. 4A-4C are flow diagrams showing methods for performing authentication according to example embodiments of the invention;

FIGS. 5A-5E are set notation diagrams illustrating example information restrictions according to example embodiments of the invention; and

FIG. 6 is a block diagram showing an electronic device which may benefit from the teachings of the invention.

### DETAILED DESCRIPTION OF THE DRAWINGS

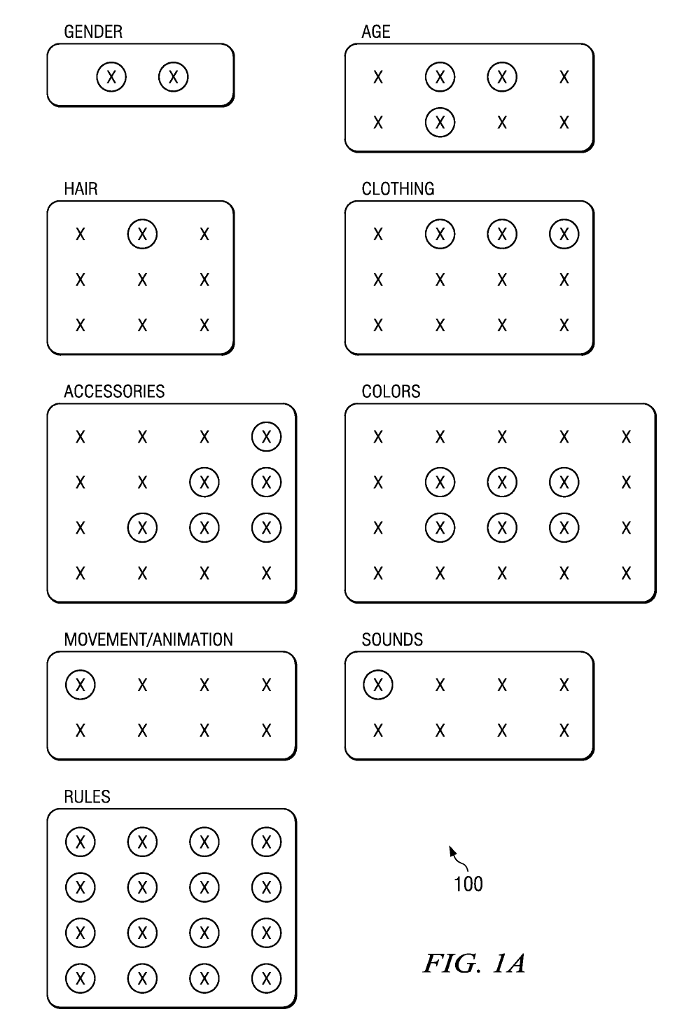

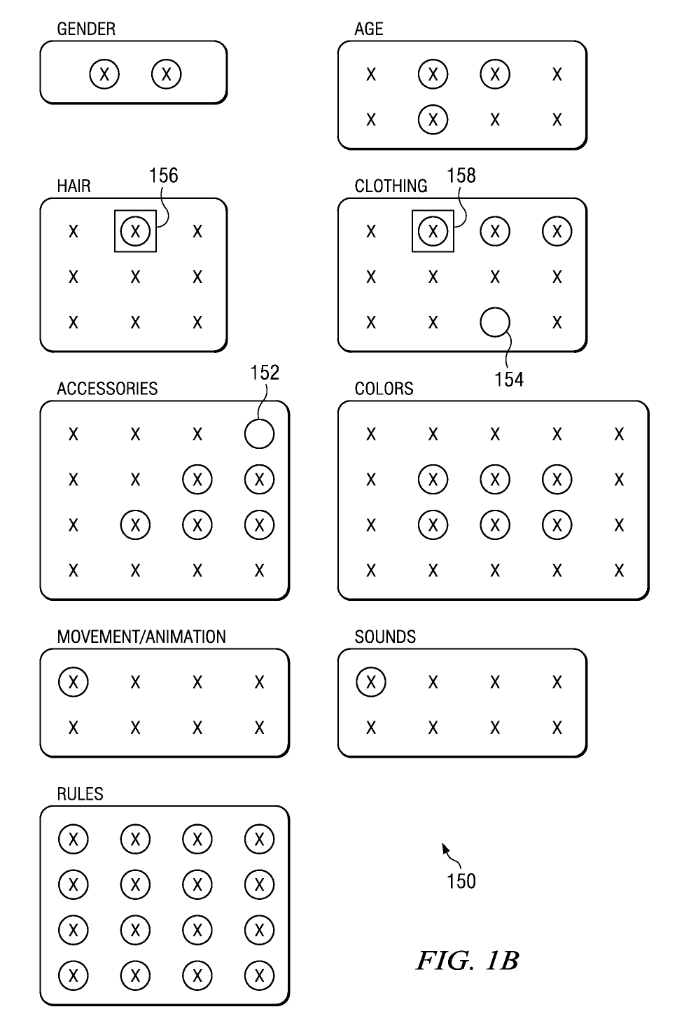

An example embodiment of the present invention and its potential advantages are best understood by referring to FIGS. 1A through 6 of the drawings.

An avatar may be a visual representation associated with a user, a user account, and/or the like. For example, a user may utilize an avatar when communicating with another user. In another example, a user may utilize an avatar when playing a game. A user may have one or more avatars associated with one or more user accounts. For example, a user may have more than one avatar which may be utilized in a game. In another example, a user may have a single avatar which may be used in a game and a social networking service.

A virtual environment may comprise a two dimensional representation of a virtual location, a three dimensional representation of a virtual location, a photograph, an image, a video, and/or the like. For example, a virtual environment may comprise a collection of images of a museum. In such an example, an avatar may navigate information related to museum exhibits utilizing the images. A virtual environment may be comprised of one or more virtual locations.

An avatar may be a part of a visual representation of information. For example, information may be represented as one or more virtual locations. For example, one set of information may be represented as the inside of a box, while another set of information may be represented as the outside of a box. In such an example, accessing the information represented by the inside of the box may be performed by moving the avatar to the virtual location of being inside the box.

An avatar may be a visual representation of a person, an animal, an object, and/or the like. An avatar may have one or more characteristics which may differentiate it from another avatar. It may be desirable to allow a user to set and/or modify a characteristic associated with an avatar. For example, a user may want to set the gender of an avatar. An avatar may have dynamic properties. For example, an avatar may have certain animation and/or movement associated with different scenarios. For example, an avatar may perform an animated sequence, such as facial movement, when conversing. In another example, an avatar may perform a movement when moving from one virtual location to another.

In an example embodiment, and avatar property may change over time. For example, an avatar may become associated with a group. In such an example, the avatar may have an avatar characteristic related to the group. In another example, an avatar characteristic associated with age may change over time. For example, an avatar characteristic associated with facial hair, hair color, a skin wrinkle, and/or the like may be modified to reflect aging of an avatar.

FIGS. 1A and 1B are block diagrams showing example characteristics which may be associated with an avatar according to an example embodiment of the invention. It should be understood, however, that the avatar characteristics of FIGS. 1A and 1B as illustrated and hereinafter described are merely illustrative of characteristics which may be associated with an avatar, and therefore, should not be taken to limit the scope of the invention.

FIGS. 1A and 1B illustrate various characteristic groups according to example embodiments of the invention. In an example embodiment, each characteristic group may have one or more characteristics. It should be understood that a characteristic associated with an avatar may be organized by a group, a sub group, no group, and/or the like. It should be further understood that the characteristic groups illustrated in FIGS. 1A and 1B are merely examples and should not limit the scope of the invention.

In the example embodiment 100 of FIG. 1A, it can be seen that there are characteristic groups for gender, age, hair, clothing, accessories, colors, movement, sounds, and rules. It can be further seen that there are various characteristics which have been set.

In an example embodiment, the gender characteristic group may comprise a characteristic for male, a characteristic for female, a characteristic for neuter, and/or the like. In an example embodiment, the age characteristic group may comprise a characteristic which may be associated with the age represented by an avatar, such as facial wrinkles, posture, and/or the like. In an example embodiment, the age characteristic group may comprise a value representing an age. In an example embodiment, the hair characteristic group may comprise one or more characteristics associated with the hair of an avatar. For example, the hair characteristic group may comprise one or more color characteristics, one or more style characteristics, and/or the like.

In an example embodiment, the clothing characteristic group may comprise one or more characteristics associated with the clothing of an avatar. For example, the clothing characteristic group may have one or more characteristics relating to one or more articles of clothing, such as a scarf, a hat, a shirt, a dress, a set of pants, a coat, and/or the like. In an example embodiment a clothing characteristic may relate to text, an image, and/or the like which may relate to an article of clothing. For example, a shirt may have a logo on it. In another example, a scarf may have a name on it.

In an example embodiment, an accessories characteristic group may comprise one or more characteristics related to an accessory associated with an avatar. For example an accessory characteristic may relate to an avatar carrying a mobile phone. In another example, an accessory characteristic may relate to an avatar wearing a headset.

In an example embodiment, the colors characteristic group may relate to one or more colors associated with one or more characteristics of an avatar. For example, there may be a color characteristic associated with a shirt characteristic. In another example, a color characteristic may be associated with the skin color of an avatar.

In an example embodiment, the movement characteristic group may comprise one or more characteristics which relate to movement and/or animation associated with an avatar. For example, a movement characteristic may relate to animation of the avatar when interacting with another avatar. In another example, a movement characteristic may relate to the way an avatar walks.

In an example embodiment, a sounds characteristic group may comprise one or more characteristics which relate to a sound associated with an avatar. For example, a sound characteristic may relate to a sound associated with the talking of an avatar. In another example, a sound characteristic may relate to a sound associated with a movement of an avatar. In an example embodiment, a sound characteristic may comprise timbre, rhythm, a musical work, and/or the like.

In an example embodiment, a rules characteristic group may comprise one or more characteristics which relate to behavior of an avatar, characteristic selection criteria for an avatar, and/or the like. For example, a rule characteristic may relate to an animation performed by an avatar when an object, a region, the avatar of another user, and/or the like is encountered. In another example, a rule characteristic may relate to limiting a clothing characteristic based upon gender.

In the example embodiments of FIGS. 1A and 1B, symbol X relates to a characteristic of an avatar. A circle around symbol X relates to a characteristic of an avatar which has been set. For example, a characteristic may be set by default, by a user and/or the like. A square around a set characteristic denotes a characteristic which may not be reset. For example, there may be a shirt logo characteristic which may not be modified by a user. A circle which is not surrounding a symbol X relates to a characteristic which may not be set. For example, there may be a characteristic related to an article of clothing which may not be set by a user. It should be understood that there may be various reasons to prevent the setting of a characteristic and/or the resetting of a characteristic. It should be further understood that a condition may arise where a characteristic which previously was not allowed to be set may become allowed to be set. It should also be understood that a condition may arise where a characteristic which previously was allowed to be set may no longer be allowed to be set.

In the example embodiment 150 of FIG. 1B, it can be seen that there are characteristic groups for gender, age, hair, clothing, accessories, colors, movement, sounds, and rules. In the example embodiment, it can be further seen that there are various characteristics which have been set. In an example embodiment, block 156 may relate to a hair characteristic which has been set and may not be reset. In an example embodiment, block 158 may relate to a clothing characteristic which has been set and may not be reset. In an example embodiment, block 152 may relate to an accessory characteristic which may not be set. In an example embodiment, block 154 may relate to a clothing characteristic which may not be set.

It should be understood that selecting a characteristic may relate to the setting or resetting of a characteristic. In addition, selecting may comprise setting and/or resetting one or more characteristics. For example, selecting may comprise setting a hair characteristic, resetting another hair characteristic, setting an age characteristic, and resetting a color characteristic. In another example, a selection may comprise the setting of blocks 156 and 158 and the resetting of blocks 152 and 154.

It should be understood that the characteristic groups illustrated in FIGS. 1A and 1B are only examples of characteristic groups that may be associated with an avatar. An avatar may have all, more, or fewer characteristic groups. Furthermore, an avatar may have characteristic groups other than those illustrated. For example, there may be a face characteristic group, a body characteristic group, a voice characteristic group, and/or the like. In another example, there may be no accessories characteristic group. It should be understood that a characteristic may be grouped differently than the examples of FIGS. 1A and 1B. For example, a color characteristic may be grouped with a characteristic to which the color relates, a color group, and/or the like. For example, a hair color characteristic may be in a hair characteristic group, a color group, and/or the like.

It should be understood that an avatar characteristic may comprise a visual attribute, a non-visual attribute, and/or the like. For example, a visual attribute may relate to the visual representation of an avatar, such as hair color, clothing, and/or the like. In another example, a non-visual attribute may relate to a group affiliation, user account information, an emotion, a health status, and/or the like.

In some cases, it may be desirable for an avatar characteristic to relate to a characteristic of another avatar. For example, there may be a group of avatars with which an avatar may be associated. In such an example, an avatar may have a characteristic selection associated with the group of avatars. For example, a multiplayer game may comprise a user group, a guild, and/or the like. In this example, each avatar in the group may comprise a common characteristic selection, such as a group affiliation characteristic, a clothing color, a logo, an accessory, and/or the like.

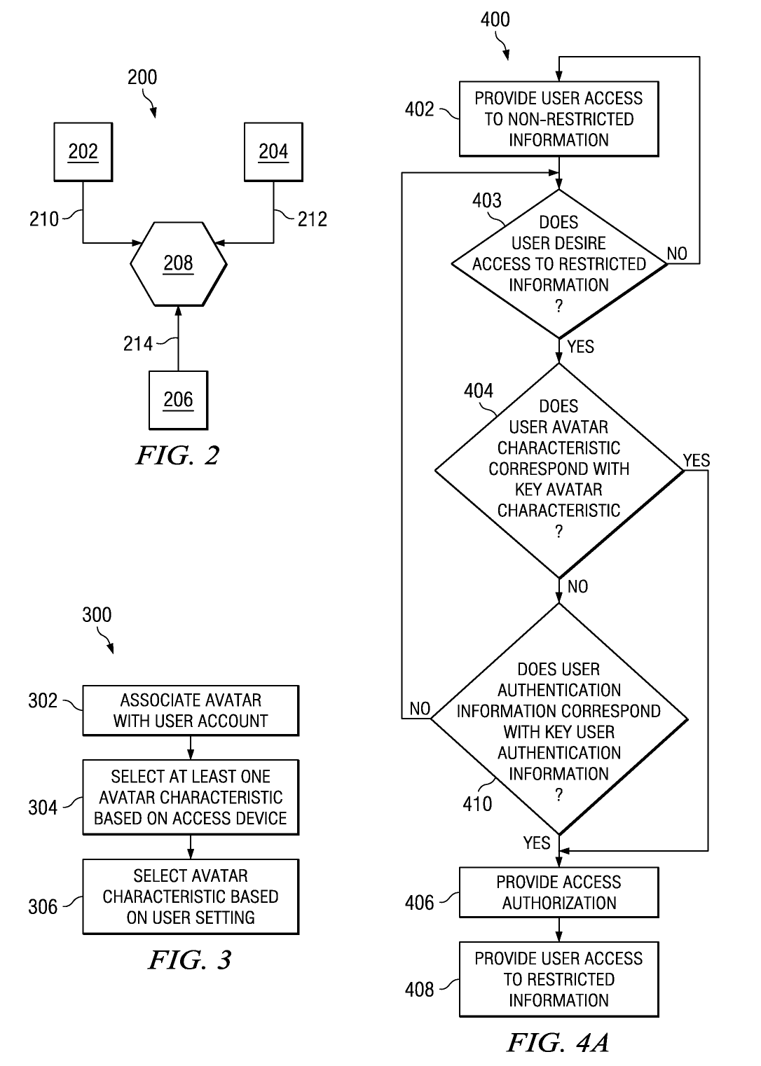

FIG. 2 is a block diagram showing a system 200 which may benefit from the teachings of the invention. It should be understood, however, that the system of FIG. 2 as illustrated and hereinafter described is merely illustrative of a system, and therefore, should not be taken to limit the scope of the invention.

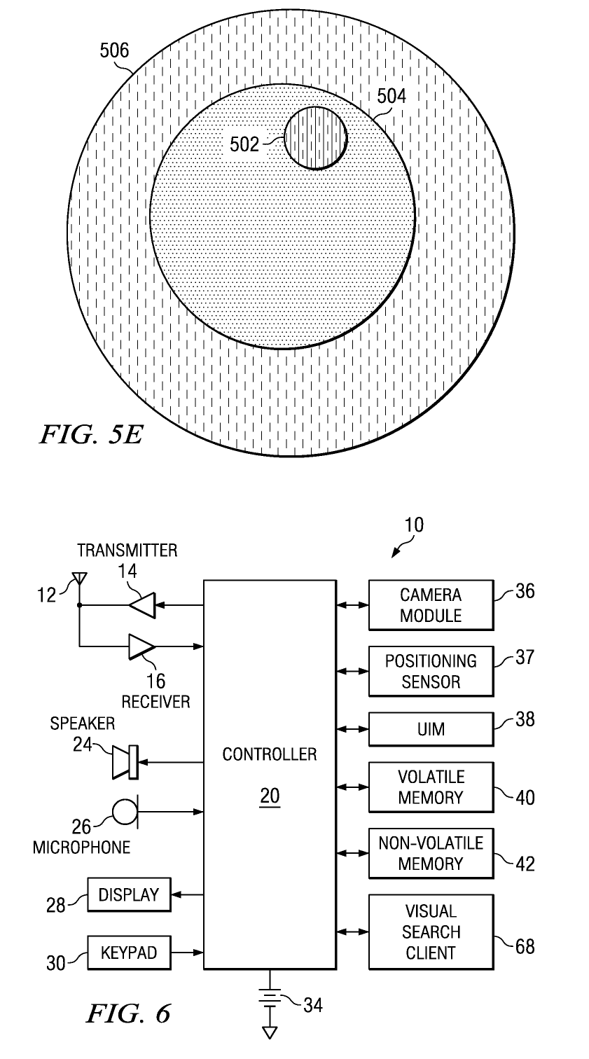

System 200 may comprise a server 208, and one or more access devices, for example access device 202, access device 204, and access device 206. In an example embodiment, server 208 and access devices 202, 204, and 206 may be coupled to each other directly or indirectly. In an example embodiment, server 208 may comprise a computer program which may utilize an avatar. For example, server 208 may comprise a computer program which may comprise a multi-player game, a social networking application, an information repository, and/or the like. It should be understood that server 208 may comprise more than one apparatus. For example, server 208 may comprise a communication apparatus, a database, a computational apparatus, an authentication server, and/or the like. An access device, for example access device 202, may be used to interact with server 208. For example, an access device, such as access device 202, may be an electronic device, for example electronic device 10 of FIG. 6, a computer, and/or the like. In an example embodiment, link 210 may provide communication between access device 202 and server 208. In an example embodiment, link 212 may provide communication between access device 204 and server 208. In an example embodiment, link 214 may provide communication between access device 206 and server 208. A link, for example link 210, may comprise internet communication, wireless communication, cellular communication, and/or the like.

An access device, for example access device 202, and/or a server, for example server 208, may comprise information related to an avatar. For example, access device 202 may comprise characteristic information associated with an avatar, for example avatar characteristic information 100 of FIG. 1A. In another example, access device 202 may comprise user account information and server 208 may comprise avatar characteristic information associated with the avatar of the user account. In yet another example, access device 202 may comprise characteristic information associated with an avatar and server 208 may comprise other characteristic information associated with an avatar.

In an example embodiment, information related to an avatar may be utilized by server 208. For example server 208 may utilize information related to an avatar when providing virtual environment information to a user. For example, server 208 may utilize avatar information related to access device 202 to generate information to be sent to access device 204. In such an example, server 208 may send to access device 204 a representation of a virtual environment which contains a representation of the avatar related to access device 202. For example, if server 208 comprises a multiplayer game, server 208 may utilize at least part of the avatar information related to access device 202 to inform access device 204 of the avatar's virtual proximity.

In an example embodiment, server 208 may comprise a multiplayer game. In such an example, access device 202 may be an access device for a first player, access device 204 may be an access device for a second player, and access device 206 may be an access device for a third player. In this example, an avatar associated with the first user may interact with an avatar associated with the second player.

It may be desirable to associate an avatar characteristic with a property of an access device. For example, it may be desirable for an avatar characteristic to be associated with the physical appearance of the access device, the brand related to the access device, a user account associated with the access device, a capability of the access device, and/or the like. Such an avatar characteristic may be useful for advertisement, branding, marketing, and/or the like.

FIG. 3 is a flow diagram showing a method 300 for editing an avatar according to an example embodiment of the present invention. It should be understood, however, that the method of FIG. 3 as illustrated and hereinafter described is merely illustrative of a method for editing an avatar, and therefore, should not be taken to limit the scope of the invention.

At block 302 an avatar may be automatically associated with a user account. This block may comprise creating an avatar, retrieving information related to an existing avatar, and/or the like. For example, if a user is creating a new avatar to be associated with the user account, block 302 may comprise creation of a new avatar and associating the new avatar with the user account. In another example, if a user is editing an existing avatar, block 302 may comprise retrieving information related to an avatar associated with the user account.

At block 304, at least one avatar characteristic may be automatically selected based at least in part on an access device and/or a property of the access device, for example access device 202 of FIG. 2. Block 304 may comprise retrieving information on an access device, retrieving information external to the access device, correlating information related to an access device with information related to an avatar characteristic, and/or the like.

It should be understood that there may be various methods to determine an access device property and that the scope of the invention is not limited to the examples disclosed hereinafter. In an example embodiment, an access device may contain identification information which may uniquely identify the access device. For example, an access device may comprise a model number. In another example embodiment, the access device may be a mobile phone which contains an international mobile equipment identity (IMEI) which may uniquely identify the access device. In yet another example embodiment, an access device may comprise information related to a user account. For example, an access device may comprise information related to a network operator. In such an example, the access device may comprise a user identity module (UIM), for example UIM 38 of FIG. 6, which may comprise information relating to the company providing network service, location information related to the service, and/or the like.

It should be understood that there may be various methods for relating an avatar characteristic selection to an access device property, for example access device 202 of FIG. 2, and that the scope of the invention is not limited to the examples disclosed hereinafter. For example, an access device may comprise information relating to avatar characteristic selection. In another example, a property related to an access device may be correlated to information outside of the access device to relate to selection of an avatar characteristic. In such an example, there may be a database, for example on server 208 of FIG. 2, of one or more properties related to an access device with corresponding avatar characteristic selection information. Such a database may be used to relate an avatar characteristic selection to an access device property.

In an example embodiment, an avatar characteristic may be associated with the physical appearance of an access device. For example, if an access device has a smooth metallic appearance, a related avatar characteristic selection may provide an avatar with a smooth metallic appearance, such as a robot. In another example, a related avatar characteristic selection may provide an avatar which is carrying a graphical representation of the access device, such as a mobile phone, PDA, internet table, and/or the like. For example, a company may utilize the graphical representation for advertizing.

In another example embodiment, an avatar characteristic may be associated with a user account associated with an access device. For example, if an access device has a user account associated with a company which provides a link, for example at least a part of link 210, from the access device, it may be desirable for the avatar characteristic selection to relate to the user account. For example, if the access device is a mobile device, it may be desirable to relate the avatar characteristic selection to a mobile network provider, mobile device manufacturer, and/or the like. In such an example, if the access device is a mobile phone, it may be desirable to relate the avatar characteristic selection to the mobile phone manufacturer, mobile network operator and/or the like. In this example, an avatar characteristic may be selected so that the avatar may exhibit a color, a logo, a sound, a movement, and/or the like, associated with the mobile phone manufacturer, mobile network operator, and/or the like.

In yet another example embodiment, an avatar characteristic may be associated with information stored on a device. For example, an avatar characteristic may be associated with a phone number, contact information, stored programs, and/or the like. In an example embodiment, avatar characteristic information may be associated with information stored on another device, such as removable memory, an audio accessory, a subscriber identity module, and/or the like of the device. For example, an avatar characteristic may be associated with information stored on a subscriber identity module. In such an example, an avatar characteristic may be associated with a message, a contact, a phone call, and/or the like stored on the subscriber identity module.

In an example embodiment, one or more avatar characteristics may be associated with a combination of information related to a device. For example one or more avatar characteristics may be associated with a device and information associated with a user identity module.

In an example embodiment, one or more avatar characteristics may be associated with a mobile phone and information associated with a subscriber identity module. For example, avatar characteristics associated with a mobile phone having one subscriber identity module may differ from avatar characteristics associated with the same mobile phone having another subscriber identity module. In an example embodiment, at least a portion, for example half, of the avatar characteristics associated with a mobile phone may be associated with a user identity module connected to the mobile phone.

In an example embodiment, at block 306, avatar characteristic selection may be performed based at least in part on a user setting. For example, a user may set and/or select one or more avatar characteristics. It should be understood that the selection may be related to the avatar characteristic selection of block 304. For example, if block 304 comprises an avatar characteristic selection according to FIG. 1B, a user may not be allowed to modify the setting of block 152, block 154, block 156, and/or block 158.

In an example embodiment, method 300 may be automatically performed by an access device, for example access device 202 of FIG. 2, a server, for example server 208 of FIG. 2, and/or the like. It should be understood that avatar characteristic information may be stored at any part of method 300 and that the scope of the invention is not limited by the storing of avatar characteristic information.

In a system, for example system 200 of FIG. 2, there may be various restrictions associated with information. For example, there may be non-restricted information, restricted information, and/or the like. In an example embodiment, non-restricted information may be characterized by information which may be accessed regardless of authorization. For example, non-restricted information may relate to information accessible by any user of a system. In another example, non-restricted information may relate to any information accessible by a user who is allowed to use a system. In such an example, non-restricted information may relate to information accessible by any user who has an account on the system.

It may be desirable to restrict information based upon a user avatar characteristic. For example, there may be information which may be restricted for a user who has an avatar which does not exhibit a company logo, a hair color, an accessory, a group characteristic, and/or the like. In such an example, it may be desirable to utilize avatar characteristic information associated with a user for access authorization. For example, a user avatar characteristic related to a company logo, a hair color, an accessory, a group characteristic, and/or the like may be utilized for access authorization. In an example embodiment there may be one or more user avatar characteristics utilized for access authorization. For example, an avatar characteristic related to a company logo and an avatar characteristic related to hair color may be utilized for access authorization. In an example embodiment, a group avatar characteristic may be utilized to perform access authorization for restricted information related to the group. For example, a group avatar characteristic associated with a bird watching group may be utilized when performing access authorization for a chat room associated with the bird watching group.

In an example embodiment, restricted information may relate to information associated with a virtual location. In such an embodiment, an avatar may need to be authorized to enter a virtual location. For example, restricted information may relate to the inside of a virtual building. In such an example, the user may express a desire to enter the virtual building by having an associated avatar approach a door, a gate, a pathway, a bridge, a location boundary, a semitransparent demarcation, and/or the like. In an example embodiment, there may be no visual demarcation associated with the virtual location. For example, there may be a virtual location comprising restricted information which may be characterized as an invisible bubble.

In another example embodiment, restricted information may relate to supplemental information related to non-restricted information. For example, there may be non-restricted information represented by a virtual message board. In such an example, there may be restricted information which may be provided to an authorized user, and not provided to an unauthorized user. For example, there may be non-restricted information representing a message for all users, and restricted information representing a message for users of avatars related to an avatar group. In such an example, a user's desire for restricted information may be assumed. For example, when information related to a message board is provided, it may be desirable to perform authentication for the restricted information without any action by the user. In another example, restricted information may relate to a virtual location, a virtual object, an image, and/or the like which may only be provided to an authorized user. In such an example, there may be a virtual building, a virtual lot, a virtual city, a virtual region, a virtual planet, a virtual representation of a real world area, and/or the like in an unrestricted virtual location which may only be seen by an authorized user. In an example embodiment, a virtual location related to a real world location, such as a corporation building, an exhibition center, and/or the like, may have similar information restrictions.

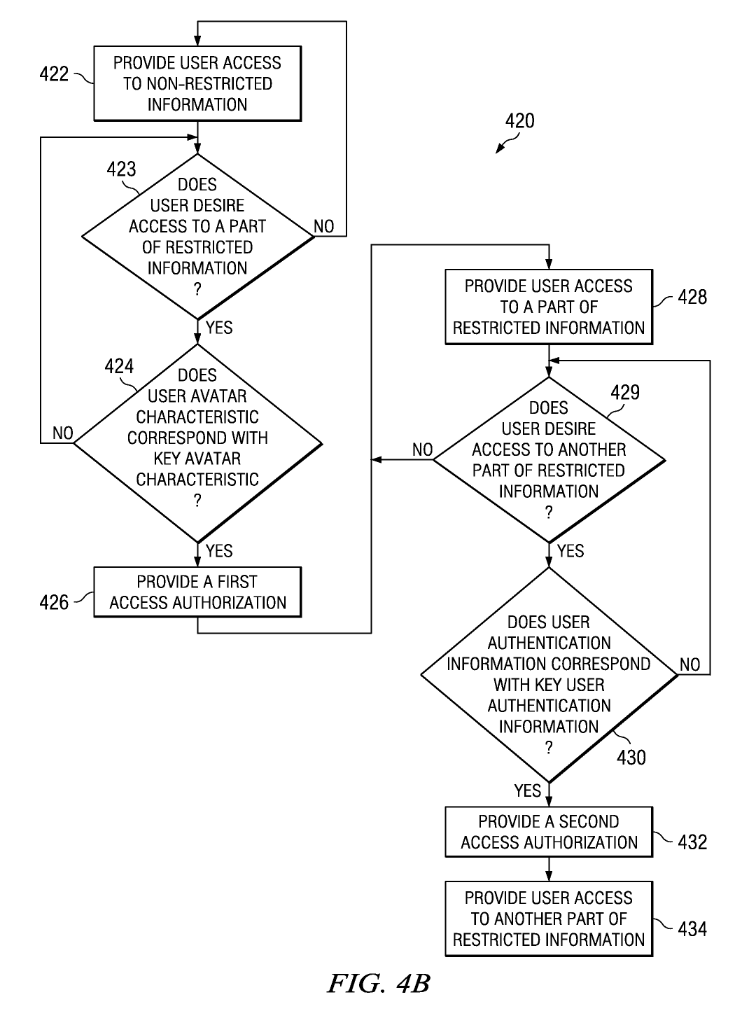

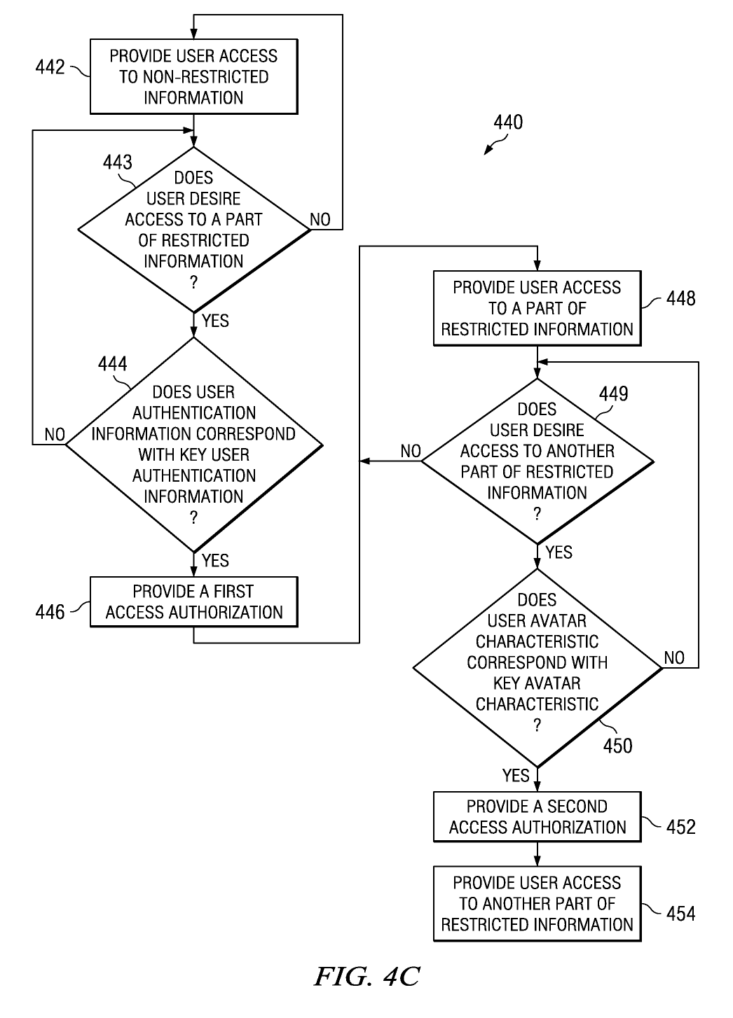

FIGS. 4A-4C are flow diagrams showing methods for performing authentication according to example embodiments of the invention. It should be understood, however, that the methods of FIGS. 4A-4C as illustrated and hereinafter described is merely illustrative of methods of performing authentication, and therefore, should not be taken to limit the scope of the invention.

In an example embodiment, method 400 of FIG. 4A, method 420 of FIG. 4B, and/or method 440 of FIG. 4C may be performed in whole or in part by an access device, for example access device 202 of FIG. 2, a server, for example server 208 of FIG. 2, and/or the like.

The key avatar characteristic of the various blocks of FIGS. 4A-4C may relate to one or more authentication criteria related to an avatar characteristic. For example, a key avatar characteristic may relate to an avatar characteristic associated with an avatar group. In such an example, the key avatar characteristic related to the avatar group characteristic may be used for access authorization for information restricted by the avatar group. In such an example, a key avatar characteristic may correspond with block 152, block 154, block 156, and block 158 of FIG. 1B. In another example, a key avatar characteristic may relate to an access device. For example, a company may restrict information based upon the display of a company logo. In such an example, an avatar having a characteristic related to a visual attribute which displays the company logo may be provided access to restricted information. Key avatar characteristic information may be stored on a server, for example server 208 of FIG. 2. For example a server administrator may store key avatar characteristic information on a server. In an example embodiment, a user may be informed of key avatar characteristic information. For example a user may be informed of key avatar characteristic information associated with restricted information. In an example embodiment a user may be able to select whether key avatar characteristic information is provided. For example, a user may be able to enable and/or disable the providing of key avatar characteristic information when attempting to access restricted information.

The key user authentication information of the various blocks of FIGS. 4A-4C may relate to one or more criteria related to authenticating a user. For example, key user authentication information may comprise, a password, information describing a movement, an image, and/or the like. User authentication information may be information stored on a device, information provided by a user and/or device, and/or the like. For example, user authentication information may be provided by a user by performing an appropriate motion with a device. In such an example, the device may utilize a motion sensor to record the movement performed by the user to generate the user authentication information. In another example, the user may have stored user authentication on a device. For example, a user may have stored a password in a device. In this example, the device may provide the user authentication information without the user providing any information. Key user authentication information may be stored on a server, for example server 208 of FIG. 2. For example, a server administrator may store key user authentication information on a server. In another example, key user authentication information may relate to information associated with a user account. In such an example, a password, gesture, and/or the like which may be associated with a user account may also serve as key user authentication information. In an example embodiment, at least some information related to key user authentication information may be communicated to a user. For example, a user may receive information related to a password, gesture, and or the like. In an example embodiment, an avatar may demonstrate a movement related to key user authentication information. For example, an avatar may demonstrate a forgotten part of a movement related to key user authentication information.

FIG. 4A is a flow diagram illustrating a method 400 for performing authentication according to an example embodiment of the invention. At block 402, a user is provided with access to non-restricted information. At block 403, a determination may be made as to whether the user desires access to restricted information. It should be understood that determination of user desire for restricted information may comprise an action or inaction by the user, another user, and/or the like, such as in the previously provided virtual location example. It should also be understood that user desire for restricted information may be implied and/or assumed, such as in the previously provided virtual message board example. If the user does not desire access to restricted information at block 403, method 400 may return to block 402.

If at block 403, it is determined that the user desires access to restricted information, method 400 may proceed to block 404. At block 404, it is determined whether a user avatar characteristic corresponds with a key avatar characteristic. In an example embodiment the key avatar characteristic may be related to access authorization of the restricted data. In an example embodiment, the determination of block 404 may involve comparing one or more key avatar characteristics with one or more user avatar characteristics. In an example embodiment, the determination of block 404 may involve determining if all key avatar characteristics correspond to user avatar characteristics. In another example embodiment, the determination of block 404 may involve determining if at least one key avatar characteristic corresponds to at least one user avatar characteristic.

It should be understood that a query of a user avatar characteristic may or may not be required. For example, a server, such as server 208 of FIG. 2, which may be utilizing information related to an avatar may already have access to a user avatar characteristic. In another example, user avatar characteristic information may be provided at block 403 after a determination of user desire for restricted information. If a user avatar characteristic corresponds with a key avatar characteristic, access authorization is provided at block 406. At block 408, the user is provided access to restricted information.

If, at block 404, it is determined that a user avatar characteristic does not correspond with a key avatar characteristic, at block 410 it is determined whether user authentication information corresponds with key user authentication information related to access authorization of the restricted data. User authentication information may be provided by a user, an access device, for example access device 202 of FIG. 2, a server, for example server 208 of FIG. 2, and/or the like. If, at block 410 it is determined that user authentication information corresponds with key user authentication information, the flow proceeds to block 406. If, at block 410 it is determined that user authentication information does not correspond with key user authentication information, method 400 may return to block 403.

FIG. 4B is a flow diagram illustrating a method 420 for performing authentication according to an example embodiment of the invention. At block 422, the user is provided with access to non-restricted information. At block 423 a determination may be made as to whether the user desires access to restricted information. It should be understood that determination of user desire for restricted information may comprise an action or inaction by the user, another user, and/or the like, such as in the previously provided virtual location example. It should also be understood that user desire for restricted information may be implied and/or assumed, such as in the previously provided virtual message board example. If the user does not desire access to restricted information at block 423, method 420 may return to block 422. If at block 423, it is determined that the user desires access to a part of restricted information, method 420 may proceed to block 424

At block 424, it is determined whether a user avatar characteristic corresponds with a key avatar characteristic. In an example embodiment, the key avatar characteristic may relate to access authorization of the restricted data. In an example embodiment, the determination of block 424 may involve comparing one or more key avatar characteristics with one or more user avatar characteristics. In an example embodiment, the determination of block 404 may involve determining if all key avatar characteristics correspond to user avatar characteristics. In another example embodiment, the determination of block 424 may involve determining if at least one key avatar characteristic corresponds to at least one user avatar characteristic.

It should be understood that a query of a user avatar characteristic may or may not be required. For example, a server, such as server 208 of FIG. 2, which may be utilizing information related to an avatar may already have access to a user avatar characteristic. In another example, avatar characteristic information may be provided at block 423 after a determination of user desire for restricted information. If, at block 424, it is determined that a user avatar characteristic does not correspond with a key avatar characteristic, method 420 may return to block 423.

If, at block 424, a user avatar characteristic corresponds with a key avatar characteristic, a first access authorization is provided at block 426. At block 428, the user is provided access to a part of restricted information. At block 429, if the user desires access to another part of restricted information, method 420 may proceed to block 430. If the user does not desire access to another part of restricted information at block 429, method 420 may return to block 428. It should be understood that determination of user desire for restricted information may comprise an action or inaction by the user, another user, and/or the like, such as in the previously provided virtual location example. It should also be understood that user desire for restricted information may be implied and/or assumed, such as in the previously provided virtual message board example.

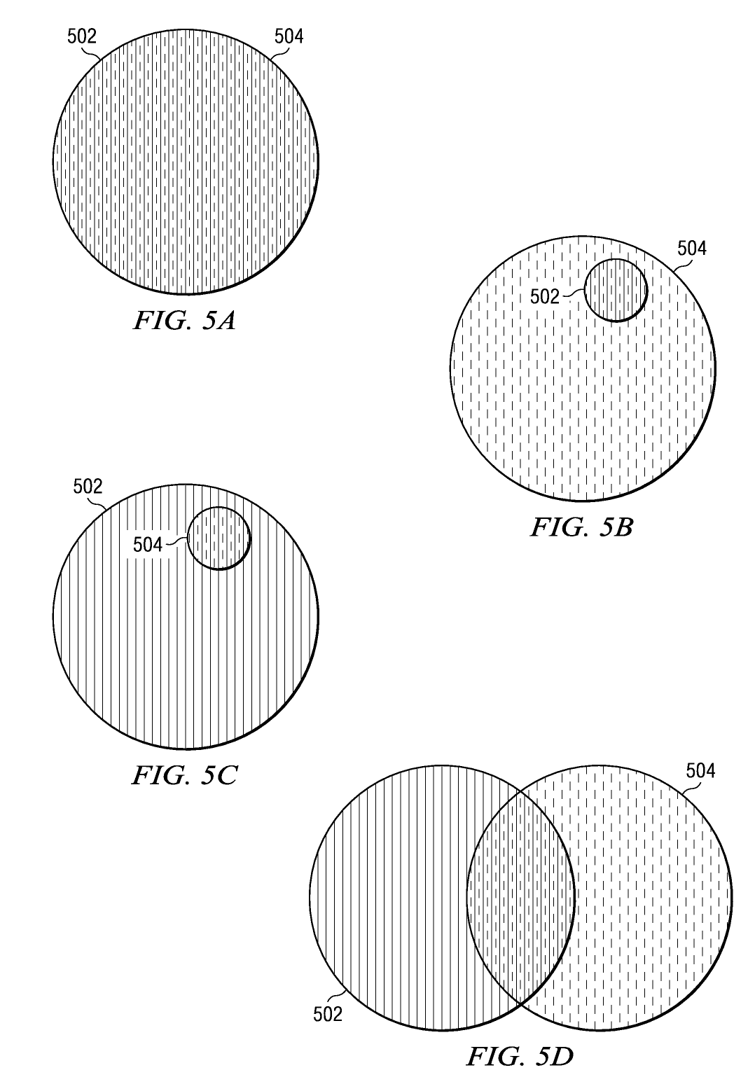

At block 430 it is determined whether user authentication information corresponds with key user authentication information related to access authorization of the restricted data. User authentication information may be provided by a user, an access device, for example access device 202 of FIG. 2, a server, for example server 208 of FIG. 2, and/or the like. If, at block 430 it is determined that user authentication information does not correspond with key user authentication information, method 420 may return to block 428. If, at block 430 it is determined that user authentication information corresponds with key user authentication information, method 420 may proceed to block 432. At block 432, a second access authorization is provided. At block 434, the user may be provided with access to another part of restricted information. It can be seen that the method 420 may be used to provide access authorization for an information restriction arrangement as in the example of FIG. 5B.

FIG. 4C is a flow diagram illustrating a method 440 for performing authentication according to an example embodiment of the invention. At block 442, the user is provided with access to non-restricted information. At block 443, it is determined whether the user desires access to a part of the restricted information. It should be understood that determination of user desire for restricted information may comprise an action or inaction by the user, another user, and/or the like, such as in the previously provided virtual location example. It should also be understood that user desire for restricted information may be implied and/or assumed, such as in the previously provided virtual message board example. If at block 443, it is determined that the user does not desire access to a part of restricted information, method 440 may return to block 442.

At block 443, if it is determined that the user desires access to a part of restricted information, method 440 may proceed to block 444. At block 444 it is determined whether user authentication information corresponds with key user authentication information related to access authorization of the restricted data. User authentication information may be provided by a user, an access device, for example access device 202 of FIG. 2, a server, for example server 208 of FIG. 2, and/or the like. If, at block 444 it is determined that user authentication information corresponds with key user authentication information, method 440 may proceed to block 446. If, at block 444 it is determined that user authentication information does not correspond with key user authentication information, method 440 may return to block 443. At block 446, a first access authorization is provided. At block 448, the user may be provided with access to a part of restricted information.

At block 449, it is determined as to whether the user desires access to another part of restricted information. It should be understood that determination of user desire for restricted information may comprise an action or inaction by the user, another user, and/or the like, such as in the previously provided virtual location example. It should also be understood that user desire for restricted information may be implied and/or assumed, such as in the previously provided virtual message board example. If the user does not desire access to another part of restricted information at block 449, method 440 may return to block 448. If, at block 449, the user desires access to another part of restricted information, method 440 may proceed to block 450.

At block 450, it is determined whether a user avatar characteristic corresponds with a key avatar characteristic. In an example embodiment, a key avatar characteristic may relate to access authorization of the restricted data. In an example embodiment, the determination of block 450 may involve comparing one or more key avatar characteristics with one or more user avatar characteristics. In an example embodiment, the determination of block 450 may involve determining if all key avatar characteristics correspond to user avatar characteristics. In another example embodiment, the determination of block 450 may involve determining if at least one key avatar characteristic corresponds to at least one user avatar characteristic. If, at block 450, it is determined that a user avatar characteristic does not correspond with a key avatar characteristic, method 440 may return to block 449.

If, at block 450, it is determined that a user avatar characteristic corresponds with a key avatar characteristic, a second access authorization may be provided at block 452. At block 448, the user is provided access to another part of restricted information. It can be seen that the method 440 may be used to provide access authorization for an information restriction arrangement as in the example of FIG. 5C.

It should be understood that there may be one or more information restrictions and that the scope of the invention is not limited by these examples. In an example embodiment, there may be no non-restricted information for a user to access. In another example embodiment, there may be more than one access authorization associated with an avatar characteristic. In another example embodiment, there may be more than one access authorization associated with user authentication.

FIGS. 5A-5E are set notation diagrams illustrating example information restrictions according to example embodiments of the invention. It should be understood, however, that the information restriction of FIGS. 5A-5E as illustrated and hereinafter described is merely illustrative of examples of information restriction, and therefore, should not be taken to limit the scope of the invention.

In FIGS. 5A-5E, a boundary 502 relates to information restricted by an access authorization based at least in part on user authentication information, for example access authorization 410 of FIG. 4A. A boundary 504 relates to information restricted by an access authorization based at least in part on avatar characteristic information, for example access authorization 406 of FIG. 4A.

FIG. 5A is a set notation diagram illustrating an example embodiment where information is restricted by user authentication information and user avatar characteristic information. In the example embodiment of FIG. 5A, it can be seen that user authentication restriction boundary 502 and avatar characteristic boundary 504 coincide. In this example, the restricted information within boundary 502 and boundary 504 may require a user authentication access authorization and user avatar characteristic access authorization when providing access to the restricted information.

FIG. 5B is another set notation diagram illustrating an example embodiment where information is restricted by user authentication information and user avatar characteristic information. In the example of FIG. 5B, it can be seen that user authentication restriction boundary 502 lies within avatar characteristic boundary 504. In this example, the restricted information within boundary 504 and outside of boundary 502 may require user avatar characteristic access authorization. In this example, the restricted information within boundary 502 may require user avatar characteristic access authorization and a user authentication access authorization.

FIG. 5C is yet another set notation diagram illustrating an example embodiment where information is restricted by user authentication information and user avatar characteristic information. In the example of FIG. 5C, it can be seen that avatar characteristic restriction boundary 504 lies within user authentication boundary 502. In this example, the restricted information within boundary 502 and outside of boundary 504 may require a user authentication access authorization. In this example, the restricted information within boundary 504 may require user avatar characteristic access authorization and a user authentication access authorization.

FIG. 5D is still another set notation diagram illustrating an example embodiment where information is restricted by user authentication information and user avatar characteristic information. In the example of FIG. 5D, it can be seen that the user authentication boundary 502 and the avatar characteristic boundary of 504 partly overlap. In this example, the restricted information within boundary 502 and outside of boundary 504 may require a user authentication access authorization. In this example, the restricted information within boundary 504 and outside of boundary 502 may require user avatar characteristic access authorization. In this example, the restricted information within boundary 502 and also within boundary 504 may require user avatar characteristic access authorization and a user authentication access authorization.

FIG. 5E is a set notation diagram illustrating an example embodiment where information is restricted by user authentication information, user avatar characteristic information, and an additional access authorization defined by boundary 506. The additional access authorization may comprise an access authorization based at least in part on avatar characteristic information, user authentication information, and/or the like. For example, boundary 506 may relate to access authorization based on a different avatar characteristic than the avatar characteristic related to boundary 504. In another example, boundary 506 may relate to access authorization based on a different user authentication than the user authentication related to boundary 502.

In the example of FIG. 5E, it can be seen that boundary 502 lies within boundary 504, and that boundary 504 lies within boundary 506. In this example, the restricted information within boundary 506 and outside of boundary 504 may require the additional access authorization. In this example, the restricted information within boundary 504 and outside of boundary 502 may require user avatar characteristic access authorization and the additional access authorization. In this example, the restricted information within boundary 502 may require user avatar characteristic access authorization, a user authentication access authorization, and the additional access authorization.

It should be understood that there may be various methods for invoking access authorization. For example, restricted information may be represented by a virtual location, such as a building, a region, an object, and/or the like. In such an example, an avatar may proceed to a part of the representation, for example a door, a gateway, and/or the like to invoke access authorization. It should be understood that an access authorization may relate to one or more accesses to restricted information. In an example embodiment, an access authorization may be performed for every attempt to access restricted information, periodic attempts to access restricted information, the first attempt to access restricted information, and/or the like. For example, access authorization may be performed the first time a user accesses restricted information. However, in the same example, the user may then access non-restricted information and later return to access the restricted information without another access authorization.

FIG. 6 is a block diagram showing an electronic device, for example, electronic device 10, which may benefit from the teachings of the invention. It should be understood, however, that a electronic device as illustrated and hereinafter described is merely illustrative of an electronic device that would benefit from embodiments of the present invention and, therefore, should not be taken to limit the scope of the present invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, GPS devices and other types of electronic systems, may readily employ embodiments of the present invention. Furthermore, devices may readily employ embodiments of the present invention regardless of their intent to provide mobility.

Embodiments of the present invention will be primarily described below in conjunction with mobile communications applications. However, it should be understood that embodiments of the present invention may be utilized in conjunction with a variety of other applications, both in the mobile communications industries and outside of the mobile communications industries.

The electronic device 10 comprises an antenna 12 (or multiple antennae) in operable communication with a transmitter 14 and a receiver 16. The electronic device 10 further comprises a controller 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, wireless networking protocols, such as 802.11, short range wireless protocols, such as Bluetooth, wibree, and/or the like.

It is understood that the controller 20 comprises circuitry desirable for implementing audio and logic functions of the electronic device 10. For example, the controller 20 may comprise a digital signal processor device, a microprocessor device, various analog to digital converters, digital to analog converters, and other support circuits. Control and signal processing functions of the electronic device 10 are allocated between these devices according to their respective capabilities. The controller 20 thus may also comprise the functionality to convolutionally encode and interleave message and data prior to modulation and transmission. The controller 20 may additionally comprise an internal voice coder, and may comprise an internal data modem. Further, the controller 20 may comprise functionality to operate one or more software programs, which may be stored in memory. For example, the controller 20 may operate a connectivity program, such as a conventional Web browser. The connectivity program may then allow the electronic device 10 to transmit and receive Web content, such as location-based content and/or other web page content, according to a Wireless Application Protocol (WAP), Hypertext Transfer Protocol (HTTP), and/or the like, for example.

The electronic device 10 may also comprise a user interface including an output device such as a ringer, a conventional earphone and/or speaker 24, a microphone 26, a display 28, and/or a user input interface, which are coupled to the controller 20. The user input interface, which allows the electronic device 10 to receive data, may comprise any of a number of devices allowing the electronic device 10 to receive data, such as a keypad 30, a touch display (not shown) or other input device. In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the controller 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 comprises hardware, such as a lens or other optical component(s), and/or software for creating a digital image file from a captured image. Alternatively, the camera module 36 may comprise only the hardware for viewing an image, while a memory device of the electronic device 10 stores instructions for execution by the controller 20 in the form of software for creating a digital image file from a captured image. In an example embodiment, the camera module 36 may further comprise a processing element such as a co-processor which assists the controller 20 in processing image data and an encoder and/or decoder for compressing and/or decompressing image data. The encoder and/or decoder may encode and/or decode according to a standard format, for example, a JPEG standard format.

The electronic device 10 may further comprise a user identity module (UIM) 38. The UIM 38 may be a memory device having a built in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a mobile subscriber. In addition to the UIM 38, the electronic device 10 may be equipped with memory. For example, the electronic device 10 may comprise volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may additionally or alternatively comprise an EEPROM, flash memory or the like. The memories may store any of a number of pieces of information, and data. The information and data may be used by the electronic device 10 to implement the functions of the electronic device 10. For example, the memories may comprise an identifier, such as an international mobile equipment identification (IMEI) code, which may uniquely identify the electronic device 10.

Although FIG. 6 illustrates an example of a electronic device which may utilize embodiments of the present invention, it should be understood that the electronic device 10 of FIG. 6 is merely an example device that may utilize embodiments of the present invention. For example a device having a processing element for managing memory operations may utilize embodiments of the present invention. For example, such a device may also comprise or otherwise be in communication with a memory device. Such a device may comprise some form of user interface. For example, such devices could be, but are not limited to, portable digital assistants (PDAs), pagers, mobile computers, desktop computers, televisions, gaming devices, laptop computers, cameras, video recorders, GPS devices and other types of electronic systems. A processing element such as those described above may be embodied in various ways. For example, the processing element may be embodied as a processor, a coprocessor, a controller or various other processing means or devices including integrated circuits such as, for example, an ASIC (application specific integrated circuit), FPGA (field programmable gate array), and/or the like.

Without in any way limiting the scope, interpretation, or application of the claims appearing below, it is possible that a technical effect of one or more of the example embodiments disclosed herein may be providing a representation of an access device property in an avatar characteristic. Another possible technical effect of one or more of the example embodiments disclosed herein may be providing at least partial information authorization based at least in part on an avatar characteristic.

Embodiments of the present invention may be implemented in software, hardware, application logic or a combination of software, hardware and application logic. The software, application logic and/or hardware may reside on an access device, a server, and/or a computing device in communication with an access device and/or server. If desired, part of the software, application logic and/or hardware may reside on an access device, part of the software, application logic and/or hardware may reside on a server, and part of the software, application logic and/or hardware may reside on a computing device in communication with an access device and/or server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a processor configured to
determine a property associated with an access device; and
automatically select a characteristic of an avatar based at least in part on said property.

2. The apparatus of claim 1, wherein said processor is further configured to associate said avatar with a user account.

3. The apparatus of claim 1, wherein said processor is further configured to select a second characteristic of said avatar based at least in part on a user selection.

4. The apparatus of claim 1, wherein said automatic selection comprises modification of availability of an avatar characteristic for setting by a user.

5. The apparatus of claim 1, wherein said automatic selection comprises setting of an avatar characteristic associated with said avatar.

6. The apparatus of claim 1, wherein said access device comprises an electronic device.

7. The apparatus of claim 1, wherein said access device comprises a mobile phone.

8. The apparatus of claim 1, wherein said property comprises a unique identifier.

9. The apparatus of claim 8, wherein said unique identifier comprises an international mobile equipment identity.

10. The apparatus of claim 1, wherein said apparatus comprises a user identity module.

11. The apparatus of claim 1, wherein said property of said access device comprises at least one property from a group consisting of location information, network operator information, a capability of said access device, and appearance of said access device.

12. The apparatus of claim 1, wherein said characteristic comprises at least one characteristic from a group consisting of a color, an image, a logo, a sound, an accessory, and a movement.

13. The apparatus of claim 1, wherein said property of said access device relates to a user account associated with said access device.

14. A method, comprising:
determining a property associated with an access device; and
automatically selecting a characteristic of an avatar based at least in part on said property.

15. The method of claim 14, further comprising associating said avatar with a user account.

16. The method of claim 14, further comprising selecting a second characteristic of said avatar based at least in part on a user selection.

17. The method of claim 14, wherein said automatically selecting comprises modifying availability of an avatar characteristic for setting by a user.

18. The method of claim 14, wherein said automatically selecting comprises setting of an avatar characteristic associated with said avatar.

19. A computer-readable medium encoded with instructions that, when executed by a computer, perform:
determining a property associated with an access device; and
automatically selecting a characteristic of an avatar based at least in part on said property.

20. An apparatus, comprising:
a processor configured to:
compare at least one user avatar characteristic with at least one key avatar characteristic;
determine a first access authorization based at least in part on said comparing of said at least one user avatar characteristic;
compare user authentication information with key user authentication information; and
determine a second access authorization based at least in part on said comparing of said user authentication information.

21. The apparatus of claim 20, wherein said processor is further configured to provide user access to restricted information based at least in part upon said first access authorization.

22. The apparatus of claim 20, wherein said processor is further configured to provide user access to restricted information based at least in part on said second access authorization.

23. The apparatus of claim 20, wherein said processor is further configured to provide user access to restricted information based at least in part on said first access authorization and said second access authorization.

24. The apparatus of claim 20, wherein said processor is further configured to provide user access to a first restricted information based at least in part on said first access authorization, and providing user access to a second restricted information based at least in part on said second access authorization.

25. The apparatus of claim 20, wherein said key avatar characteristic comprises a group avatar characteristic.

26. The apparatus of claim 20, wherein said user authentication information comprises movement information.

27. The apparatus of claim 20, wherein said determining said first access authorization is performed before said determining said second access authorization.

28. A method, comprising:
comparing at least one user avatar characteristic with at least one key avatar characteristic;
determining a first access authorization based at least in part on said comparing of said at least one user avatar characteristic;
comparing user authentication information with key user authentication information; and
determining a second access authorization based at least in part on said comparing of said user authentication information.

29. The method of claim 28, further comprising providing user access to restricted information based at least in part upon said first access authorization.

30. The method of claim 28, further comprising providing user access to restricted information based at least in part on said second access authorization.

31. The method of claim 28, further comprising providing user access to restricted information based at least in part on said first access authorization and said second access authorization.

32. The method of claim 28, further comprising providing user access to a first restricted information based at least in part on said first access authorization, and providing user access to a second restricted information based at least in part on said second access authorization.

33. The method of claim 28, wherein said key avatar characteristic comprises a group avatar characteristic.

34. The method of claim 28, wherein said determining said first access authorization is performed before said determining said second access authorization.

35. The method of claim 28, wherein said user authentication information comprises movement information.

36. A computer program product comprising a computer-readable medium bearing computer program code embodied therein for use with a computer, the computer program code comprising:
code for comparing at least one user avatar characteristic with at least one key avatar characteristic;
code for determining a first access authorization based at least in part on said comparing of said at least one user avatar characteristic;
code for comparing user authentication information with key user authentication information; and
code for determining a second access authorization based at least in part on said comparing of said user authentication information.
